(19) United States
(12) Patent Application Publication
(10) Pub. No.: US 2014/0028830 A1
(43) Pub. Date: Jan. 30, 2014

(54) DEPLOYABLE DEVICES AND METHODS OF DEPLOYING DEVICES

(71) Applicants: Kevin Kieffer, Washington, DC (US); James Wiggins, Thurmont, MD (US); Barclay E. Roman, Clifton, VA (US); Peter Owen, Monrovia, MD (US); Conrad Zeglin, Rockville, MD (US); Todd Stawarz, Fairfax, VA (US); Mark Meister, Rockville, MD (US)

(72) Inventors: Kevin Kieffer, Washington, DC (US); James Wiggins, Thurmont, MD (US); Barclay E. Roman, Clifton, VA (US); Peter Owen, Monrovia, MD (US); Conrad Zeglin, Rockville, MD (US); Todd Stawarz, Fairfax, VA (US); Mark Meister, Rockville, MD (US)

(21) Appl. No.: 13/467,496

(22) Filed: May 9, 2012

Related U.S. Application Data
(63) Continuation-in-part of application No. 13/441,215, filed on Apr. 6, 2012.
Application No. 13/441,215 is a continuation of application No. 12/326,225, filed on Dec. 2, 2008, now Pat. No. 8,174,557.

(51) Int. Cl. H04N 5/225

(52) U.S. Cl. CPC H04N 5/2252
USPC 348/82

(57) ABSTRACT

A system for obtaining and displaying such images and environmental information from environments is disclosed, as well as a sensor device and a host configured for use in the system, the sensor device having camera assemblies, environmental sensors, and being connected to the host via a wireless communications link. Methods for obtaining and presenting the images and environmental information using the system are also disclosed.

### CROSS REFERENCE TO RELATED APPLICATIONS

The present application is a continuation-in-part of U.S. patent application Ser. No. 13/441,215, filed on Apr. 6, 2012, which is a continuation of U.S. patent application Ser. No. 12/326,225, filed on Dec. 2, 2008, the disclosures of which are incorporated by reference in their entirety.

### STATEMENT REGARDING FEDERALLY SPONSORED RESEARCH OR DEVELOPMENT

Pursuant to 35 U.S.C. §202(c)(6) of the Patent Act, Applicants specify that this invention was made, in part, with U.S. government support under Department of Defense (DOD) grant number N65538-08-M-0016. The government may have certain rights in the invention.

### FIELD OF THE INVENTION

The invention relates to the detection and collection of information and images in an environment, and in particular to systems, methods, and apparatus for collecting the information and images.

### BACKGROUND

Collection of images and detection of environmental conditions, particularly in a hazardous environment, is critical to rapid situational assessment and damage control. For example, damage sustained on board a boat or other naval vessel, whether due to enemy attack or accident, presents a situation which may require rapid situational assessment and damage control in a potentially hazardous environment. Rapid situational assessment of environments such as the compartment of a ship, including views within the compartment and detection of heat and/or other potentially hazardous environmental conditions, is essential for coordinating a response and mitigating damage to rescuers, responders, victims, and property.

During an event including a hazardous environment, responders may need to inspect rooms, areas, or other compartments that may have been exposed to dangerous and possibly lethal environmental conditions. Even if the hazardous environmental conditions were known, response may be slowed due to the need for responders to don protective gear and physically avoid hazards. In some situations, it may be impossible for a human to assess an area due to fire, flooding, or other environmental conditions for which there is no protection.

Accordingly, there is a need and desire for a system and method for assessing environmental conditions and obtaining images from potentially hazardous environments, while preserving the health and lives of the damage control teams.

### BRIEF DESCRIPTION OF THE DRAWINGS

FIG. 1 is a diagram of a system for obtaining environmental information and images, in accordance with embodiments described herein.

FIG. 2 is a diagram of a sensor device for obtaining environmental information and images, in accordance with embodiments described herein.

FIG. 3 is a schematic diagram of an electronic assembly of a sensor device for obtaining environmental information and images, in accordance with embodiments described herein.

FIG. 4 is a cross-section of a wall of an enclosure of a sensor device for obtaining environmental information and images, in accordance with embodiments described herein.

FIG. 5 shows a camera assembly used in a sensor device for obtaining environmental information and images, in accordance with embodiments described herein.

FIG. 6A is a diagram of a host for receiving and displaying environmental information and images obtained by a sensor device, for use with embodiments of a system described herein.

FIG. 6B shows a user interface displaying environmental information and images, for use with embodiments of a system described herein.

FIG. 7 is a flow chart of a method for obtaining environmental information and images, in accordance with embodiments of a system described herein.

FIG. 8 illustrates a diagram of a sensor device, in accordance with embodiments described herein.

FIG. 9 illustrates a diagram of a sensor device, in accordance with embodiments described herein.

FIG. 10 illustrates a diagram of a sensor device, in accordance with embodiments described herein.

FIG. 11 illustrates a diagram of a sensor device, in accordance with embodiments described herein.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made. Sequences of steps are not limited to those set forth herein and may be changed or reordered, with the exception of steps necessarily occurring in a certain order.

Disclosed embodiments provide for collection of images and environmental information from potentially hazardous environments. Disclosed embodiments include a system for obtaining and displaying such images and environmental information from environments, as well as various apparatuses for use in this system. Apparatuses described include a deployable sensor device and a host. Embodiments of the system and the sensor device include a sensor device having an enclosure providing protection from hazardous environmental conditions and shock, the sensor device having camera assemblies and environmental sensors for capturing images and environmental information, respectively, and a communications interface for transmitting these images and environmental information to a host for display and/or analysis. Further, disclosed embodiments include methods for obtaining the images and environmental information.

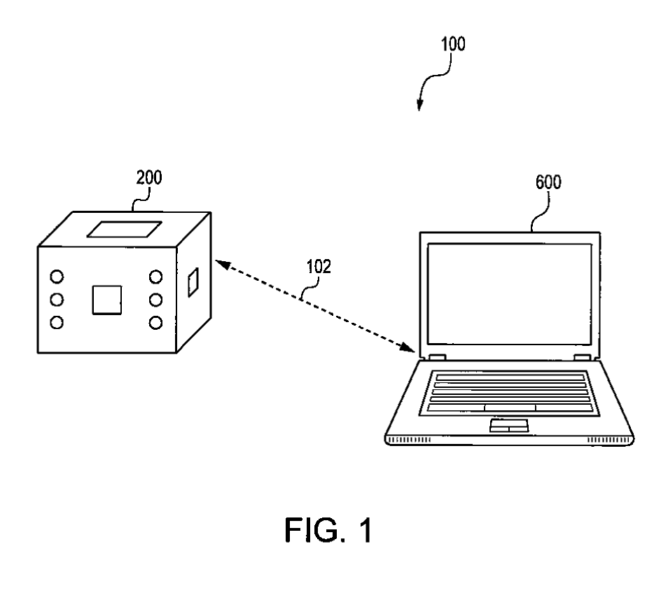

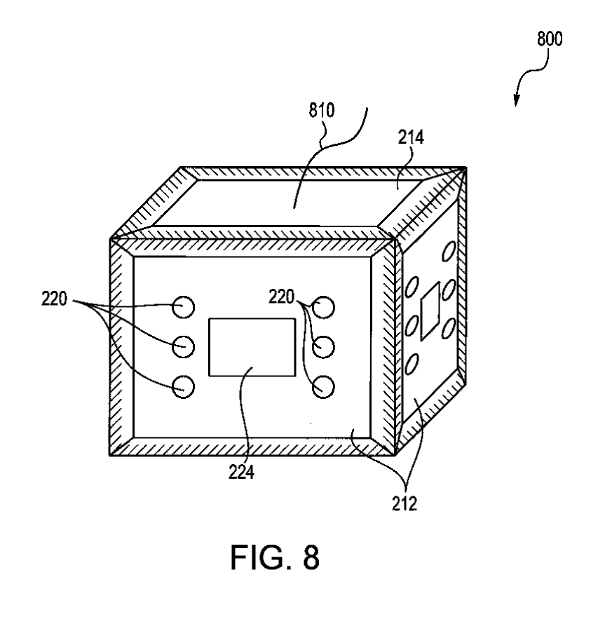

FIG. 1 shows a system 100 for obtaining environmental information and images, in accordance with embodiments described herein. System 100 includes one or more sensor devices 200 for obtaining environmental information and images, and at least one host 600 for receiving and displaying the environmental information and images from sensor device 200. Sensor device 200 and host 600 interact via a communications link 102. Communications link 102 is preferably a two-way wireless communications interface, such as an 802.11(b) signal, any other 802.11 wireless communications interface or “Wi-Fi” communications interface, a 2G, 3G, 4G, or other wireless telephone communication standard, or other wireless communication technologies commonly known in the art. In another embodiment, discussed below in connection with FIG. 8, communications interface 102 is provided by a wired communications interface, with the connecting interface configured to allow sensor device 200 to be deployed to a desired distance from the host 600.

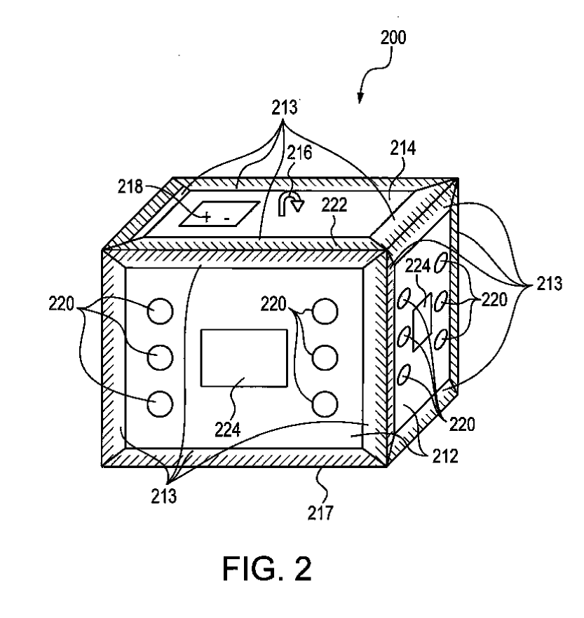

FIG. 2 is a diagram of the exterior appearance of sensor device 200, configured to obtain environmental information and images, in accordance with embodiments described herein. In system 100, sensor device 200 is preferably configured to be deployed into an environment by hand. Sensor device 200 therefore should be configured to a size and weight such that a person is capable of moving the device into the environment. For example, a person can deploy sensor device 200 by picking it up and throwing it or rolling it, for example along a ground area, into the environment. However, the main goal is to promote ease of deployment. Thus, sensor device 200 can be thrown, deployed by remote device (e.g., a robot), dropped out of a vehicle, or through any other means of moving the device into the environment. Sensor device 200 is designed for use in hazardous environments. For example, sensor device 200 is designed to operate in an environment with an ambient temperature in excess of 500 degrees for a substantially longer period of time than other sensor devices.

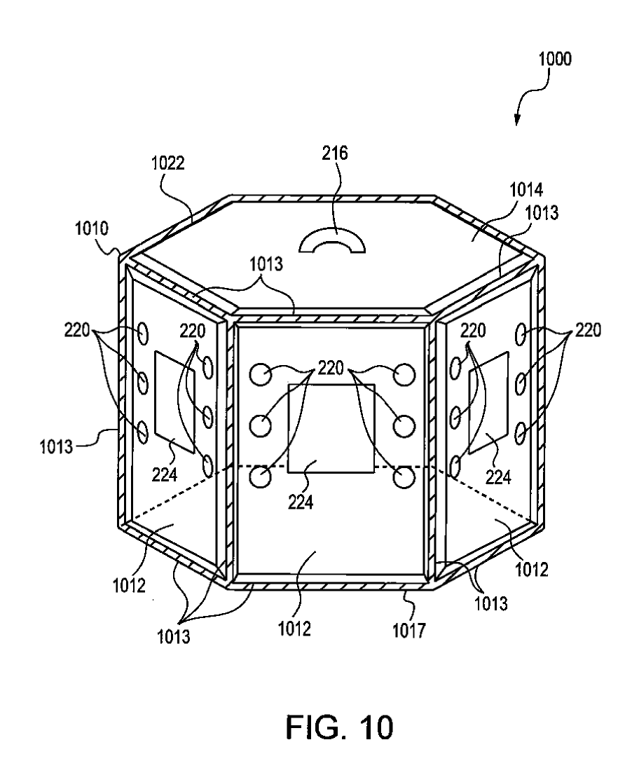

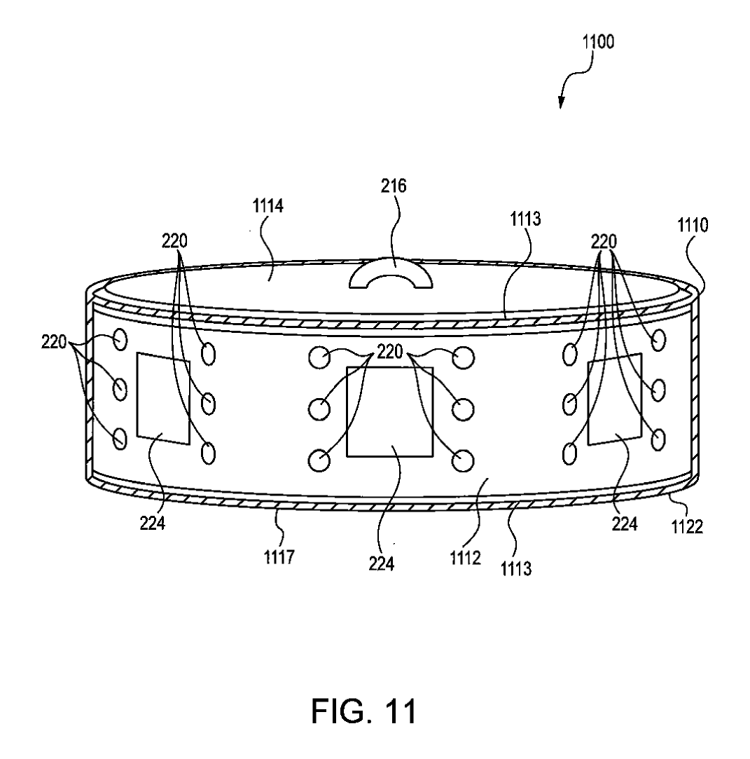

Sensor device 200 comprises an enclosure 210. In one embodiment, as shown in FIG. 2, enclosure 210 is cubic-shaped, having a top surface 214, a bottom surface 217, and four side surfaces 212. In a further embodiment, enclosure 210 is a cubic-shaped enclosure further comprising rounded or beveled edges 213 surrounding all six faces of sensor device 200. A cubic-shaped enclosure with rounded edges 213 provides for easier deployment of sensor device 200 because the shape allows for sensor device 200 to roll initially while also causing sensor device 200 to stay at rest once its trajectory ceases. Other embodiments of sensor device 200 include alternative shapes for the enclosure 210, such as spherical, hexagonal, or pyramidal shapes, or other shapes, such as those discussed further below in connection with FIGS. 10 and 11.

In a preferred embodiment, a shock-absorbing casing 222 covers edges 213 of the faces of sensor device 200, providing protection to the structural and electrical components of sensor device 200, for instance when sensor device 200 is thrown by hand. Casing 222 is located on the exterior of sensor device 200 and not protected by any insulation, and thus must be capable of withstanding temperatures and/or other environmental elements of hazardous environments. A material that burns, melts, or corrodes under environmental conditions in which sensor device 200 is designed to operate could interfere with operation of camera assemblies 500 and/or environmental sensors 220, potentially disabling sensor device 200 (FIG. 2). A preferred embodiment of casing 222 is made from silicone rubber, such as Silastic™ silicone rubber manufactured by Dow Corning™. Silicone rubber is a flexible yet durable material that is also resistant to extreme temperatures.

Enclosure 210 preferably has dimensions that permit sensor device 200 to be deployed, for example, by hand, and thus preferably has a maximum size that is less than twenty-four (24) inches in length on any one exterior surface, and more preferably, approximately six (6) inches in length on all sides. The minimum size of the enclosure 210 will be determined by the space required to house the electronics assembly 300 and the thickness of the enclosure 210.

In the embodiment of sensor device 200 shown in FIG. 2, sensor device 200 includes side surfaces 212 (two of which are visible in FIG. 2). Side surfaces 212 include environmental sensors 220 and camera portals 224.

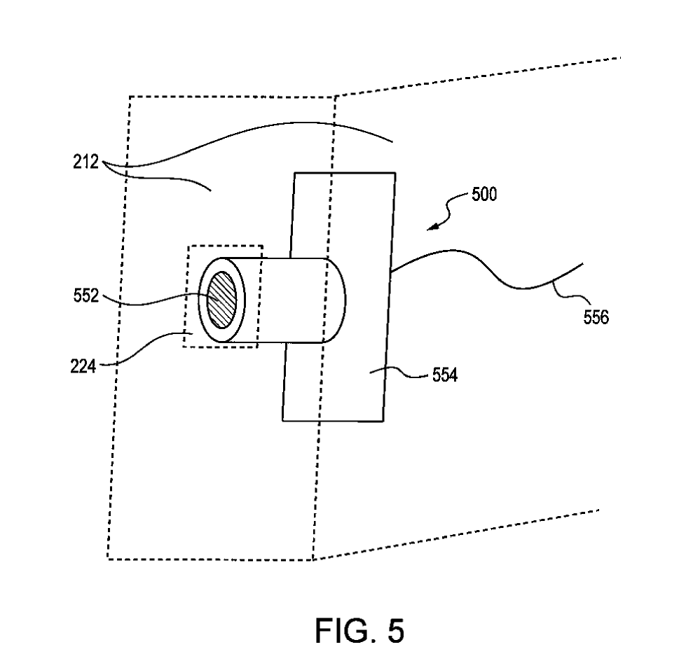

Each camera portal 224 consists of a transparent material affixed in side surface 212 providing for light to pass through the camera portal 224 to a camera assembly 500 (FIG. 5) inlaid within the side surface. Camera portal 212 is a pane of translucent material, such as, for example, quartz crystal glass, or translucent hardened plastics. Alternatively, the camera portal 224 can alternatively be a lens of the camera assembly 500 itself. Each camera portal 224 is flush with the side surface 212 in order to provide better rolling characteristics. Each side surface 212 and camera portal 224 is sealed to prevent water, smoke, and other hazards contained in the external environment from permeating sensor device 200.

Sensor device 200 includes a camera assembly 500 (FIG. 5) inlaid within at least one of its exterior surfaces 212, 213, 214. In the embodiment shown in FIG. 2, each side surface 212 of sensor device 200 has a camera assembly 500 contained within the enclosure 210, with the lens of the camera assembly 500 either located behind and protected by the respective camera portal 224, or comprising the respective camera portal itself.

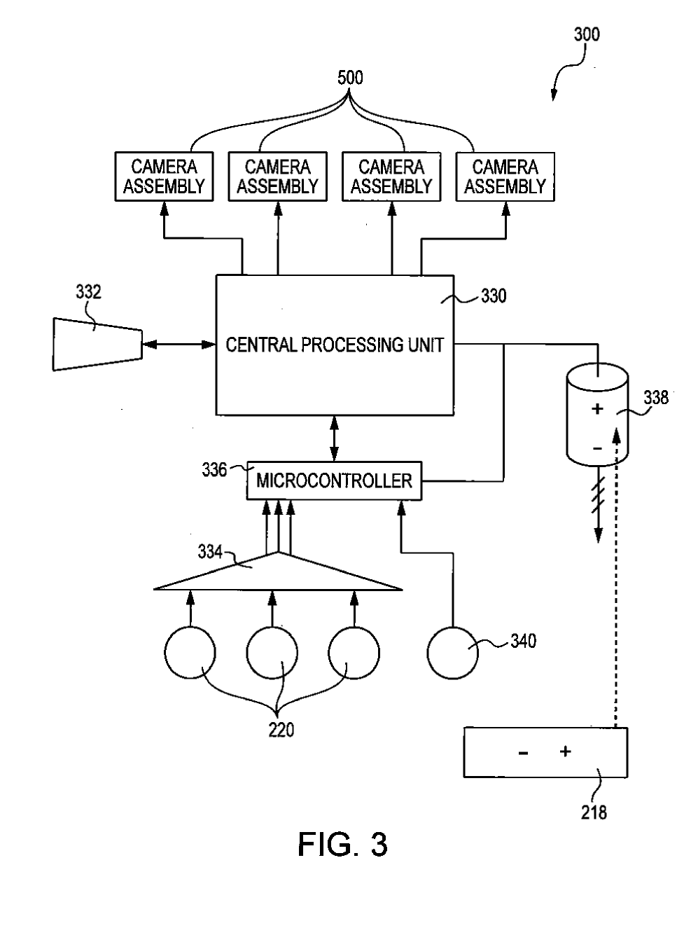

Camera assembly 500 includes a small board-level camera circuit 554 and camera lens 552. The camera circuit 554 can either consist of a bare circuit board along with a lens mount, thus requiring minimal additional circuitry for each camera assembly 500, or separated sets of components integrated into a single hardened mother board. Camera assembly 500 also includes a camera interface 556 for transmitting obtained images to a central processor 330 (FIG. 3).

Embodiments of camera assembly 500 employ any type of imaging system, including infrared or other non-visual spectra. Within the visible range, any type of camera technology is used, including CMOS or CCD imaging. While CCD camera assemblies tend to offer better intensity discrimination, CMOS camera assemblies tend to offer faster readout and lower power consumption. Camera assembly 500 is configured to obtain video images, or, alternatively, still images. Camera assembly 500 is configured to obtain color or monochromatic (i.e., black and white) images at any desired resolution that is available. Camera assembly 500 may be selected based upon a variety of factors, including resolution, sensitivity, size, weight, durability, camera interface, and method of exposure control.

In a preferred embodiment, camera assembly 500 includes a monochrome CCD imager system, with a USB interface configured to operate with a Windows™ or Linux™-based processor. Such a camera is provided by Sentech model STC-B33USB. Camera lens 552 has a focal length preferably in the range from 1.7 mm to 3.6 mm, and most preferably 2.5 mm. However, other focal lengths are within the scope of this invention. Camera assembly 500 provides for analog-to-digital conversion of the obtained image signal. Alternatively, camera assembly 500 outputs an analog image signal to central processor 330, and central processor 330 provides analog-to-digital conversion.

Camera assembly 500 is shown inlaid in a side surface 212 of a sensor device, such as sensor device shown in FIG. 2. Camera lens 552 is positioned behind camera portal 224. Camera portal 224 provides a viewpoint for camera assembly 500, while protecting the lens and providing a flush and sealed side surface of sensor device 200 (FIG. 2). In one embodiment, camera lens 552 is perpendicular to the respective side surface 212. In another embodiment, camera lens 552 is located at an angle to the respective side surface 212. For example, camera lens 552 can be directed at an angle slightly above parallel to the ground level, providing greater coverage of the environment.

Referring back to sensor device 200 of FIG. 2, the visible side surfaces 212 of sensor device 200 also include environmental sensors 220. In a preferred version of sensor device 200, environmental sensors for detecting and measuring levels of oxygen, hydrogen sulfide, and carbon monoxide in an environment would be used. It should be understood, however, that sensor device 200 could be configured to detect the presence and/or levels of any environmental condition in which there exists a commercially available environmental sensor. Various environmental sensors are known in the art, and are configured to detect temperature, smoke, or levels of various gaseous elements in the environment. For instance, known environmental sensors include sensors that detect the presence and/or levels of hydrogen sulfide; oxygen; carbon monoxide; carbon dioxide; chlorine; hydrocarbons; smoke; heat; nuclear and other radiation; poisonous gases and/or particles (e.g., anthrax); and fire suppression agents. Other known environmental sensors include sensors that detect the presence and/or levels of: audio signals; barometric pressure changes; wind speed; bacteria; and viruses.

Sensor device 200 also includes a tether attachment connector 216 to enable retrieval of sensor device 200, for example by a mechanical means that connects to the tether attachment connector 216. Tether attachment connector 216 can be used to deploy device 200, for example by swinging or lowering device 200 in a hazardous environment, and to retrieve device 200. The tether attachment connector 216 is located on a top surface 214 of sensor device 200 that is designed to face upwards when sensor device 200 is at rest. The tether attachment connector 216 can be, for example, a hook, a magnetic or electro-magnetic connection device, or any other connection device designed to allow attachment by a mechanical means that is part of a tether, such as a pole, elongated hook, rope, or cord. The tether attachment connector 216 is preferably flush with or inlaid in a surface of the enclosure 210 to minimize the effect of the tether attachment connector 216 on the rolling trajectory of sensor device 210.

Sensor device 200 also includes a charging terminal 218 on the exterior of enclosure 210. The charging terminal 218 is used to charge and/or recharge a power source 338 (FIG. 3) of sensor device 200. The charging terminal 218 is preferably located on a top surface 214 of the enclosure 210, as shown in FIG. 2. Alternatively, charging terminal 218 can be located on a side surface 212 or bottom surface 217 of the enclosure 210. The charging terminal 218 is configured to allow serial charging of multiple sensor devices 200 when the sensor devices 200 are stowed; for instance, a charging terminal 218 located on a top and a bottom surface 217 of a sensor device provides for charging of the respective power sources of multiple sensor devices 200 when the multiple sensor devices 200 were stacked on top of one another.

A bottom surface 217 of the enclosure 210 of sensor device 200—that is, a surface intended to rest on the floor when sensor device 200 comes to rest—includes extra weighting, such as a layer or object not included in other surfaces of the enclosure 210. The extra weighting of the bottom surface 217 provides for improved deployment of sensor device 200—when sensor device 200 is thrown or otherwise deployed, it is more likely that none of the side surfaces 212 having camera portals 224 and environmental sensors 220 will be facing the ground and thus incapacitated.

FIG. 3 is a schematic diagram of an electronics assembly 300 of a sensor device 200. Electronics assembly 300 includes the electronic elements of sensor device 300 electronically coupled to a central processor 330. The electronic elements shown in electronics assembly 300 include one or more camera assemblies 500, a power source 338 with an optional charging terminal 218, environmental sensors 220 coupled to an environmental sensor amplifier 334, a board temperature sensor 340, a microcontroller 336 that receives signals from the environmental sensor amplifier 334 and/or the board temperature sensor 340, and a device external communications interface 332. The elements are described further below.

Central processor 330 is configured to provide central control, data acquisition, and communications support and management for sensor device 200. Central processor 330 receives environmental information from the various environmental sensors 220, images from camera assemblies 500, and supports wireless communications via a device external communication interface 332. The environmental information and images received by the central processor 330 may be either analog or digital, and thus central processor 330 is configured to receive either analog or digital signals, and to provide analog-to-digital conversion of received analog signals. Alternatively, a separate analog-to-digital converter is included in electronics assembly 300 (such as in microcontroller 336). Central processor 330 is also preferably configured to provide compression (i.e., JPEG or MPEG-2 compression) of high-bandwidth digital data, such as still or video images, prior to the transmission of the digital data to host 600 (FIG. 1) via the device external communication interface 332.

Central processor 330 includes a software package configured to acquire and compress images and environmental sensor information, and transmit the images and environmental information over an IP network interface via the external communication interface 332. Any known wireless software package is used. For example, an open-sourced software platform such as Linux™ or any versions of the Windows™ operating system are adaptable to the instant invention. Open-sourced software generally may be freely copied, modified, and used, and thus is conducive to being adapted for use in central processor 330 of sensor device 200.

A preferable software package for central processor 330 includes a camera driver providing operation (i.e., exposure and readout) and control (i.e., exposure conditions such as shutter speed, gain, and clocking rate) of camera assembly 500. Preferably, the software package and camera driver are configured to allow for obtaining and transmitting either still or video images. A preferable software package also includes a module providing for compression of digital signals received by central processor 300. A preferable software package also includes a module for receiving and converting analog signals from environmental sensors 220 and/or board temperature sensor 340, or, alternatively, receiving digitized versions of the environmental information and board temperature information from microcontroller 336 (as further discussed below).

The software package of central processor 330 also preferably includes a module for outputting environmental, image, and/or other data to an external communications interface, i.e., device external communications interface 332. For example, image and environmental data can be output in discrete portions also known as “messages.” Each image message contains, for example, one frame of compressed or uncompressed image data from a camera assembly 500. Each environmental message contains, for example, sensor information from all environmental sensors 220 in sensor device 200. Each message is time-stamped for subsequent analysis purposes, and converted into standard TCP/IP or UDP/IP protocols, as is commonly known in the art, for transmission to the host via external communication interface 332.

Electronics assembly 300 also includes one or more environmental sensors 220. As described above, environmental sensors 220 are configured to detect the presence of and/or levels of various gaseous and other environmental conditions, including, but not limited to: hydrogen sulfide; oxygen; carbon monoxide; carbon dioxide; chlorine; hydrocarbons; smoke; heat; nuclear and other radiation; poisonous gases and/or particles (e.g., anthrax); and fire suppression agents.

Environmental sensors 220 are commonly configured to generate an analog signal indicating the presence of and/or a level of an environmental condition. This analog signal generated by environmental sensors 220 typically ranges from less than 0.1 microamps to approximately 100 microamps, depending upon the configuration of the particular environmental sensor 220 and the type and amount of the detected environmental condition in the atmosphere. Electronics assembly 300 also includes an environmental sensor amplifier 334 configured to amplify the analog signals generated by environmental sensors 220. Amplification is often necessary to render the generated analog signals conducive to analog-to-digital conversion. For instance, typical circuits providing analog-to-digital conversion require received analog signals in the range of zero (0) to five (5) volts. Thus, environmental sensor amplifier 334 is configured to provide varying levels of amplification for various environmental sensors, depending upon the amplitude range of the analog signal generated by the respective environmental sensor 220.

The electronic elements in electronics assembly 300 are sensitive to levels of heat and cold. For instance, temperatures in excess of 185 degrees Fahrenheit can render electronic elements inoperative. In addition to ambient heat frequently present in hazardous environments, electronics assembly 300 receives heat generated by the normal operation of electronic elements such as power source 338 and central processor 330. Electronics assembly 300 also includes a board temperature sensor 340 that is configured to monitor the temperature of a portion of the electronics assembly 300, and provide internal temperature information to host 600 (FIG. 1). Board temperature sensor 340 is configured to generate an analog or digital signal indicating the internal temperature of the electronics assembly 300.

Analog signals generated by environmental sensors 220 and/or board temperature sensor 340 are preferably converted to digital signals prior to processing by central processor 330 and transmission via device external communications interface 332. In one embodiment, central processor 330 is configured to provide analog-to-digital conversion of analog signals. In another embodiment, analog-to-digital conversion of analog signals is provided by a microcontroller 338 before the signals are provided to central processor 330. Microcontroller 338 includes analog-to-digital converters configured to sample analog signals from environmental sensors 220 and/or board temperature sensor 340. In this embodiment, microcontroller 338 provides the digitized signals to central processor 330 through a serial interface, such as a RS-232 interface.

Microcontroller 338, for example, includes its own software package configured to provide for acquisition of analog signals from environmental sensors 220 and/or board temperature sensor 340, analog-to-digital conversion of the received analog signals, and transmission of these signals to central controller 330. Such a software package can be written in standard C or C++ programming platform. Alternatively, the software package is adapted for use in sensor device 200 using an open-sourced platform, such as a version of Linux™ for microcontrollers.

Electronics assembly 300 also includes a power source 338 for powering electronic elements including central processor 330 and/or microcontroller 336. Power source 338 also directly powers other elements of electronics assembly 300, such as camera assemblies 500, environmental sensors 220, environmental sensors amplifier 334, board temperature sensor 340, and/or device external communications interface 332. Alternatively, power source 338 powers some or all of these elements of electronics assembly 300 through their respective interfaces with central processor 330 and/or microcontroller 336. For instance, camera assemblies 500 are interfaced to central processor 330 via a serial USB interface that provides a power signal to camera assemblies 500 as well as providing for the transmission of data.

Power source 338 preferably comprises one or more NiMH batteries. NiMH batteries typically have a nominal voltage of 1.2 volts. Depending upon the voltage necessary to power elements of electronics assembly 300, power source 338 may comprise a plurality of NiMH batteries in series. For example, in a preferred embodiment, central processor 330 and microcontroller 336 tolerates a voltage range from approximately 4.7 to 5.3 volts. Thus, four NiMH batteries, each providing a 1.2 volt charge, are linked in series to provide a 4.8 volt charge to central processor 330 and microcontroller 336. In other embodiments, power source 338 may comprise other battery technologies, such as one or more LiON batteries, for example.

Electronics assembly 300 also includes a device external communications interface 332 for transmitting image, environmental, and other information to host 600 via communications link 102 (FIG. 1). External communications interface 332 is preferably configured to transmit digital data via a wireless signal, such as a “Wi-Fi” 802.11 signal, over a range of 100 feet or more. External communications interface 332 is preferably configured to transmit data formatted in standard TCP/IP or UDP/IP protocols. External communications interface 332 preferably provides a two-way communications interface, so that sensor device 200 also receives control and other information from host 600 via communications link 102. Embodiments of external communications interface 332 comprise, for example, a compact flash wireless card with an internal or external antenna. For example, an embodiment of external communications interface 332 comprising a compact flash wireless card by EmbeddedWorks and an antenna (located either external or internal) that provides wireless 802.11 transmission of TCP/IP or UDP/IP data over 400 feet.

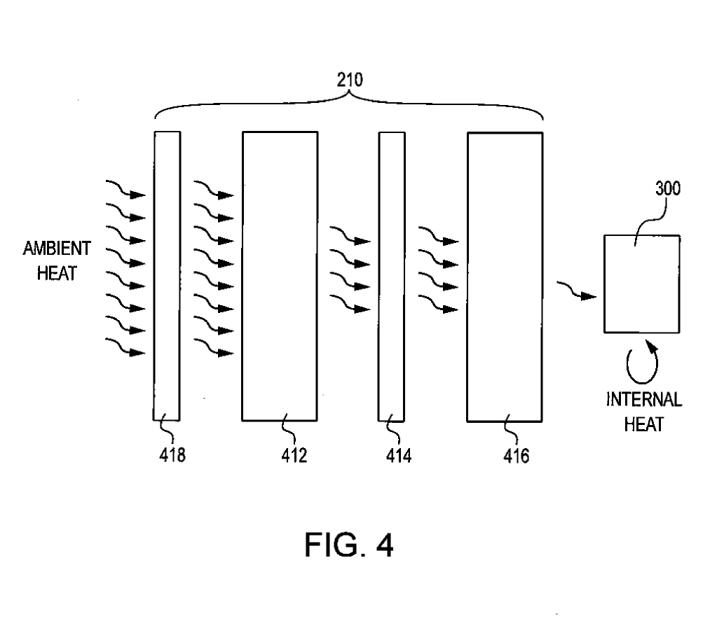

FIG. 4 is a cross-sectional diagram of a single wall of enclosure 210 of sensor device 200. The wall of enclosure 210 includes an inner structural layer 414 providing the structural integrity of the enclosure 210, an insulating layer 412 for mitigating the effects of environmental heat on electronics assembly 300, and an outer layer 418 for covering and protecting electronics assembly 300 and other components of sensor device 200.

Structural layer 414 is formed from known and readily available formable materials such as, for example, fiberglass, ceramics, engineering plastics, polycarbonate, acrylonitrile butadiene styrene (ABS), or poly-tetrafluoroethene (PTFE or Teflon™). A preferred embodiment of structural layer 414 is formed from fiberglass, because fiberglass is mechanically suited to being deployed into a hazardous environment. For instance, a structural fiberglass layer can be custom formed from known methods, and may be lightweight, resistant to shattering even when damaged, and have low thermal conductivity yet high tolerance to extreme heat and cold.

Insulating layer 412 is designed to be safe for use in temperatures in excess of 500 degrees Fahrenheit. Insulating layer 412 also provides shock absorption protection for the inner structural layer 414 and electronics assembly 300. Insulating layer 412 is formed from known and readily available formable insulating materials such as, for example, silica aerogels, ceramics, thermoplastic polyimides, Nanopore™ thermal insulation, or fiberglass.

A preferred embodiment of insulating layer 412 is formed from a silica aerogel derivative, such as Pyrogel™ manufactured by Aspen Aerogels. Pyrogel™, for example, has a thermal conductivity in the range of 0.0015 W/m-K and 0.0030 W/m-K, depending upon temperature, and has a maximum use temperature of 725 degrees Fahrenheit. Pyrogel™ also provides, some shock absorption, and has a flexible base making it less prone to cracking or shattering.

Outer layer 418 provides covering protection to the other layers of enclosure 210 and the components of sensor device 200. Outer layer 418 also includes openings for one or more camera portals 224 or sensors 220 (FIG. 2). Outer layer 418 is not protected by any insulation, and thus must be capable of withstanding temperatures and/or other environmental elements of hazardous environments. A material that burns, melts, or corrodes could interfere with operation of camera assemblies 500 and/or environmental sensors 220, potentially disabling sensor device 200 (FIG. 2). Outer layer 418 also provides some insulation to the other layers and electronics assembly 300.

Outer layer 418 is formed from known and readily available formable materials such as, for example, polyimide film, aluminum foams, fiberglass, or rubbers. In a preferred embodiment, Kapton™ polyimide film is used to form outer layer 418, because of its high tolerance to heat, thin layering, and light weight.

Sensor device 200 also includes a phase change material (PCM) layer 416 to further protect electronics assembly 300 from heat. Phase change materials are materials designed to exploit the fact that a change between phases of matter (solid, liquid, gas) either absorbs or releases energy. PCM's for electronics are designed to change from solid to liquid. By including PCM within enclosure 210, the phase change absorbs energy that would otherwise cause an increase in temperature. The phase change, then, prolongs the amount of time electronics can survive when they are being heated. However, while PCM helps protect against environmental heat, it also acts as an insulator and does not allow the dissipation of heat generated internally by electronics assembly 300. Thus, the use of PCM may reduce run time of sensor device 200 in a room-temperature environment. Therefore, another embodiment of system 100 (FIG. 1) includes multiple sensor devices 200, with some sensor devices 200 that include phase change material 416 for use in high-temperature environments, and other sensor devices 200 that do not include phase change material 416 for non-high-temperature environments (i.e., environments with an ambient temperature less than the maximum operational temperature for electronic elements of sensor device 200).

In one embodiment of a sensor device including PCM, shown in FIG. 4, phase change material 416 is an additional layer of enclosure 210. Alternatively, the interior of enclosure 210 is filled with loose phase change material 416. Loose phase change material 416 is available in microencapsulated or non-microencapsulated form. Microencapsulated PCM comprises numerous microcapsules each having a core that changes phase while suspended within a shell that stays solid. Thus, microencapsulated PCM remains granular, even after multiple use cycles, and will not melt together into a large block, unlike non-microencapsulated PCM. In addition to selecting between microencapsulated or non-microencapsulated PCM, considerations in selecting a suitable PCM for phase change material 416 include the energy required for phase change (usually expressed in terms of kilojoules per kilogram or kJ/kg), and the phase change temperature indicating the temperature at which the PCM changes phase. Microencapsulated PCM material typically provides lower energy absorption than non-microencapsulated PCM.

Preferably, an embodiment of sensor device 200 for use in high-temperature environments includes phase change material 416 requiring a high energy for phase change (usually expressed in terms of kilojoules per kilogram or kJ/kg) and having a phase change temperature slightly lower than the upper temperature limit of electronic elements in electronics assembly 300 (for instance, slightly lower than 185 degrees Fahrenheit for preferred electronic elements). For example, Microtek™ MPCM-52D™ PCM is a microencapsulated PCM with a phase-change energy of approximately 139 kJ/kg and a melting point of approximately 125 degrees Fahrenheit. Other exemplary PCM materials include Honeywell Astor™ Astorphase 54™ PCM, a non-microencapsulated PCM with a phase-change energy of 220 kJ/kg and a melting point of approximately 129 degrees Fahrenheit, and Rubitherm™ RT 54™ PCM, a non-microencapsulated PCM with a phase-change energy of 181 kJ/kg and a melting point of approximately 134 degrees Fahrenheit.

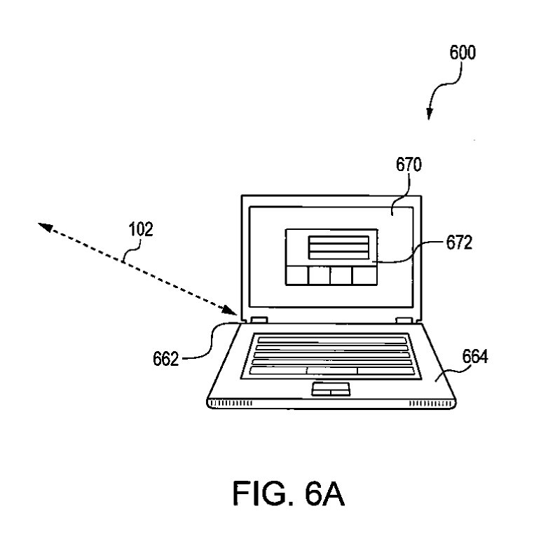

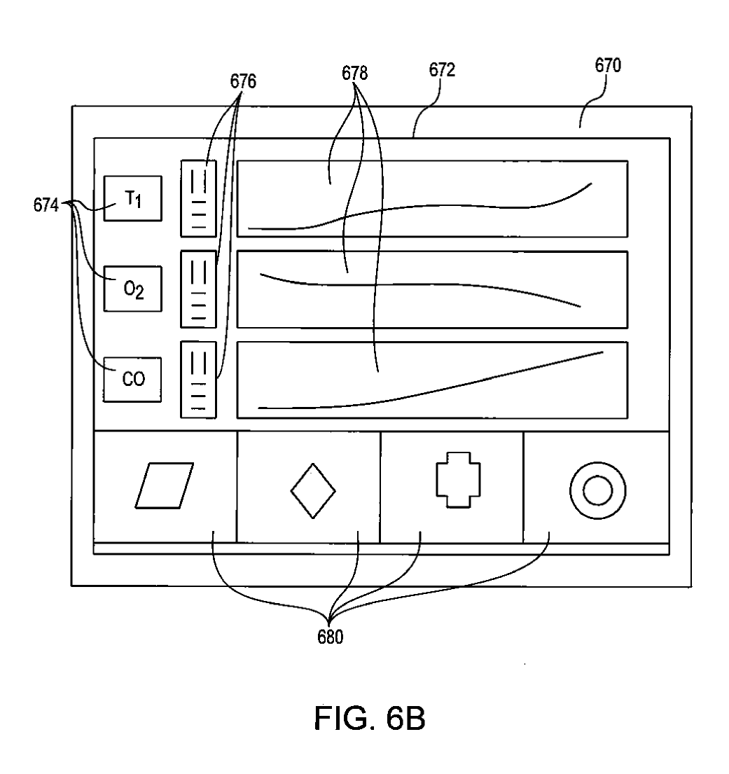

Referring back to FIG. 1, images and environmental information from sensor device 200 is transferred via communications link 202 (for example, a wireless 802.11 “Wi-Fi” communications link) to host 600. FIG. 6A is a diagram of a preferred embodiment of a host for receiving and displaying environmental information and images obtained by a portable sensor device, for use with embodiments of sensor system 100.

In the preferred embodiment, host 600 is a computer system. The computer system can be any known computer system, including, for example, a personal computer such as a laptop computer, a minicomputer, a mainframe computer, a personal digital assistant (PDA), or multiple computers in a system. For example, host 600 comprises a laptop computer with an Intel™ Core Duo™ Processor using x86 architecture. The computer system will typically include at least one display 670, input device 664, and host external communications interface 662, but may include more or fewer of these components. Typically, internal components of host 600 will also include at least one processor, as well as random access memory (RAM). The processor can be directly connected to display 670, or remotely over communication lines such as telephone lines, local area networks, or any other network for data transmission. Host 600 preferably is configured to run on a Linux™ operating system (an open source software platform).

Display 670 of host 600 displays a user interface 672 for presenting all collected images and environmental information collected and transmitted by sensor device 200. In the preferred embodiment, user interface 672 is generated by a Java-based software package, such as a variation of the PanelBuilder™ software package developed by Adaptive Methods™. However, any known or suitable user interface for interaction with cameras and/or sensors can be used.

FIG. 6B shows an embodiment of user interface 672. In a preferred embodiment of user interface 672 includes an advisory display panel 674, a control display panel 676, an environmental sensor display panel 678, and an image display panel 680.

Advisory display panel 674 displays hardware, software, and/or data advisories related to the operation of sensor device 200 and/or communications link 102 (FIG. 1). These advisories include various color codes and other images associated with various alert levels, categories, and alarms to be presented to the operator. A separate panel provides an operator interface for review of past advisories. Alarms are available for each environmental sensor 220 or environmental condition. If a certain environmental condition is detected (for example a threshold temperature), an alarm is displayed in advisory display panel 674. All such thresholds are XML configurable items and linked to a particular environmental condition detected. An operator of sensor system 100 (FIG. 1) are provided with capability to set thresholds on environmental sensor display panel 678 (discussed below).

Control display panel 676 displays and provides a user interaction with controls for managing information and images displayed on user interface 672. For example, control panel includes a timeline scroll bar for adjusting between the display of current and stored past images and environmental information in user interface 672. Control display panel 676 also displays and provides interaction with controls for controlling sensor device 200 (FIG. 2)

Environmental sensor display panel 678 provides a flexible layout for presenting all collected environmental information from environmental sensors 220. Environmental sensor display panel 678 is dynamically reconfigurable to a single or multi-column format to show all the sensors reporting from the deployed unit. Environmental information is dynamically and automatically added to environmental sensor display panel 678 as it is received. In the event that more environmental information is received than can be reasonably displayed in environmental sensor display panel 678, a vertical scroll bar is provided to scroll amongst environmental information.

Environmental sensor display panel 678 displays separate sub-panels for the environmental information captured by each environmental sensor 220 of sensor device 200 (FIG. 2), or, alternatively, displays separate sub-panels for each environmental condition detected or tested separately. A separate XY chart and/or sensor icon is displayed for each environmental sensor 220 and/or environmental condition displayed. The XY chart displays a time history on the X axis and a level on the Y axis.

Environmental sensor display panel 678 is also configured to adjust characteristics of displayed information according to various thresholds (for example, in accordance with alert levels triggering alerts in advisory display panel 674). The sensor icon and/or XY chart may vary in characteristics such as color, size, or format according to detected environmental conditions. The characteristics are stored so that an operator of sensor system 100 (FIG. 1) can review previous environmental information to see which sensors have exceeded thresholds at anytime in the past.

User interface 672 also includes an image display panel 680 configured to display images obtained by camera assemblies 500 of sensor device 200. Images are dynamically and automatically added to image display panel 680 as they are received. In the event that more images are received than can be reasonably displayed in image display panel 680, a horizontal scroll bar is provided to scroll amongst present and past images. Each individual image panel preferably has control buttons configured to, for example, rotate the individual image clockwise, provide a cursor crosshair, zoom to a cursor crosshair, and/or maximize the individual image to take up the entire display area of user interface 672. Preferably, image display panel 680 is configured to display four images in horizontal panels, each image being the most recent from each of respective four camera assemblies 500 in the previously described preferred embodiment of sensor device 200 (FIG. 2).

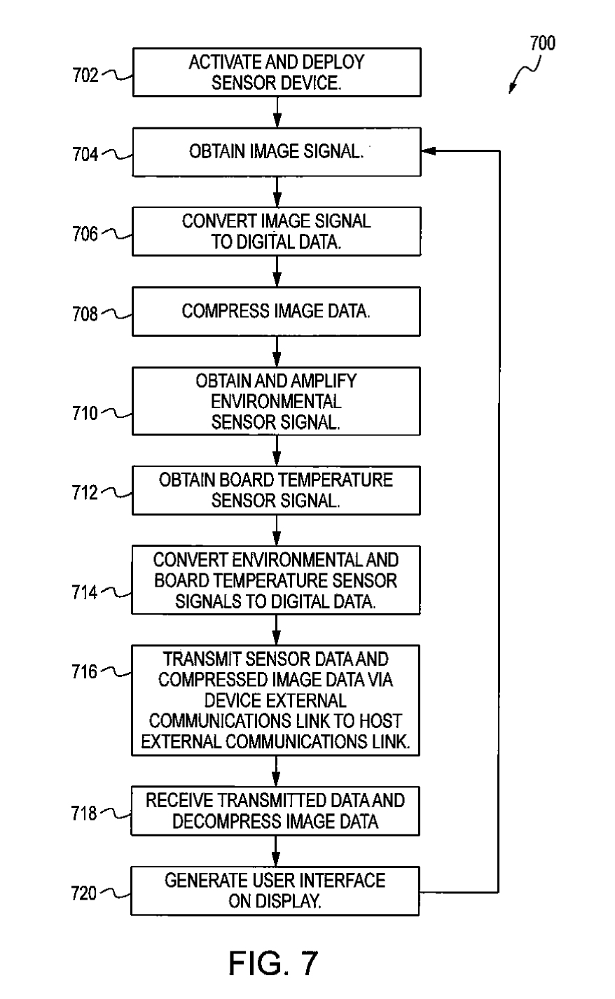

FIG. 7 is a flow chart of a method 700 for obtaining environmental information and images using sensor system 100 described above. In step 702, at least one sensor device 200 is activated and deployed. Sensor device 200 is activated, for example, by a control signal transmitted from host 600 to sensor device 200, by removing a charge from charging terminal 218 (FIG. 2), by activating a switch on sensor device 200, or by any other means of activating an electronic device. Alternatively, sensor device 200 is configured to remain activated during its functional lifetime, or during all times when it may be deployed. In step 702, sensor device 200 is deployed by any known means for deploying a small object. Preferably, sensor device 200 is deployed manually (i.e., by hand) by a person. For example, sensor device 200 may be thrown or rolled by hand, or may be swung or lowered by a tether (e.g., a rope or wired tether 810 (FIG. 8)). It should be understood that sensor device 200 may be activated either before or after deployment.

In steps 704-720, sensor system 100 obtains, transmits, and displays images and/or environmental information. It should be understood, however, that steps 704-720 may be conducted continuously, and in any sequence, except when steps necessarily occur in a certain order. Commonly, several steps will be conducted simultaneously. For example, sensor device may obtain images substantially simultaneously while obtaining environmental information, the images and environmental information may be digitized, processed, and/or transferred simultaneously or at different times, and the transmitted images and environmental information may be generated for display on user interface 672 simultaneously or at the different times.

Steps 704-708 relate to obtaining images. In step 704, one or more camera assemblies 500 of sensor device 200 capture images from the environment and convert the images to image signals. In step 706, the analog image signals are converted to digital data through analog-to-digital conversion that is provided by camera assembly 500, or by central processor 330 (FIG. 3). In step 708, the digital image data is compressed to a known compression format (e.g., PEG or MPEG-2), for instance by central processor 330.

Steps 710-714 relate to obtaining environmental information and internal temperature information. In step 710, environmental sensors 220 (FIG. 3) detect the presence of and/or levels of environmental conditions such as temperature and/or hazardous elements in the air. Environmental sensors 220 generate an analog signal according to the presence of and/or level of the particular environmental condition each environmental sensor is configured to detect. In-step 712, board temperature sensor 340 optionally detects an internal temperature of sensor device 200 and generates an analog signal according to the detected temperature. In step 714, the analog signals from environmental sensors 220 and/or board temperature sensor 340 are converted to digital data through analog-to-digital conversion that are provided by microcontroller 336 or by central processor 330 (FIG. 3).

In step 716, sensor device 200 transmits the environmental and image data via communications link 102 (FIG. 1) to host 600. Communications link 102 is a two-way communications link provided by device external communication interface 332 (FIG. 3) and host external communications interface 662 (FIG. 6A). Communications link 102 is preferably a wireless communications interface, such as an 802.11(b) signal, any other 802.11 wireless communications interface or “Wi-Fi” communications interface, a 2G, 3G, 4G, or other wireless telephone communication standard, or any other wireless communications interface known in the art. Alternatively, the data may be transmitted by a wired communications link. The transmitted data is preferably formatted by central processor 330 to be divided into a series of “messages,” each message containing data representing one or more obtained images and/or environmental sensor information. Each message is time stamped for subsequent analysis purposes, and converted into standard TCP/IP or UDP/IP protocols by central processor 330, as is commonly known in the art. The message is then transmitted to host 600 via device external communication interface 332.

In step 718, host 600 receives the transmitted environmental and image data via host external communications interface 662 (FIG. 6A). The received environmental and image data is preferably stored in random-access memory (RAM) by host 600 for immediate presentation purposes. Alternatively, or in addition to being stored in RAM, the received environmental and image data is stored on a hard drive for future analysis and/or presentation. Also in step 718, host 600 decompresses any image or environmental data that was compressed prior to transmission.

In step 720, host 600 generates a user interface 672 on display 670, presenting the received images and/or environmental information from sensor device 200. As discussed above, the most recently received images and environmental information are presented in user interface 672 along with previously received images and environmental information. Preferably, host 600 is configured to present received images and environmental information on user interface 672 automatically and dynamically, as described above.

FIG. 8 illustrates another embodiment of a sensing device 800. Sensing device 800 includes one or more camera assemblies 224 and/or sensors 220 on one or more surfaces of an enclosure, such as a side surface 212 or a top surface 214, as well as other features discussed above in connection with FIGS. 2-7, the description of which will not be repeated here. Sensor device 800 also includes a wired tether 810 connected to a top surface 214 or side surface 212 that serves as a wired communications interface between sensing device 800 and a host 600 (FIG. 1), such as a laptop computer, a smartphone or PDA, or other processor-driven device. Wired tether 810 may include power conductors, data conductors, both power conductors and data conductors, or neither power conductors nor data conductors. For example, wired tether 810 may be a standard transmission interface that is interfaced with an electronics assembly 300 (FIG. 3) of sensor device 800 and permits two-way transmission of data (including audio, video, sensor information, control information, and other data) between sensor device 800 and the host 600 (FIG. 1), providing a wired communication interface to host 600 in addition to, or instead of, a wireless communication interface. Wired tether 810 may be a powered connection sufficient to power sensor device 800 as an alternative to, or in combination with, an internal power source 338 (FIG. 3).

Wired tether 810 also permits deployment of sensor device 800 into hazardous environments through deployment techniques described above in connection with FIG. 7. For example, wired tether 810 may be used to deploy sensing device 800 by swinging or lowering sensing device 800 into a hazardous environment. If power or data conductors are included in wired tether 810, they should be suitably robust and/or reinforced so as not to break under tension. Alternatively, or in addition, wired tether 810 may include a load-bearing strength member, such as a dedicated steel wire or cable, to absorb the load of tension placed on wired tether 810. Electrical conductors providing data and/or power may be wrapped around or attached to the load-bearing strength member.

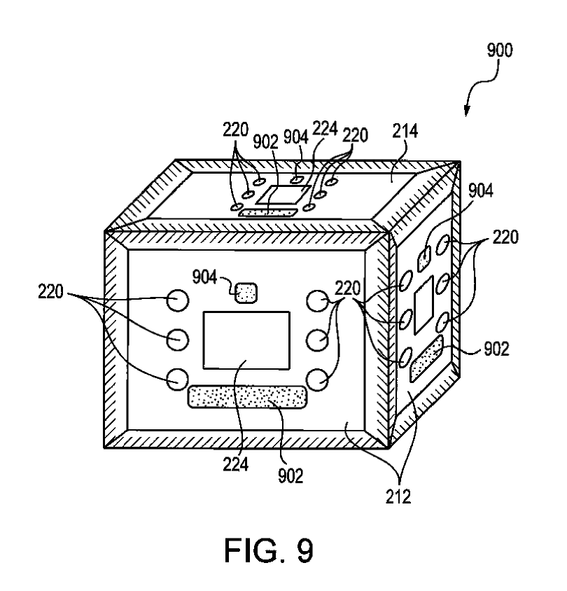

FIG. 9 illustrates another embodiment of a sensing device 900. Sensing device 900 includes one or more camera assemblies 224 and/or one or more sensors 220 on a surface of an enclosure, such as a side surface 212 or top surface 214, as well as other features discussed above in connection with FIGS. 2-8, the description of which will not be repeated here. Sensing device 900 also includes an audio speaker 902 on one or more surfaces 212, 214. Audio speaker 902 permits audio communication to be transmitted from a user at a host 600 (FIG. 1) to a person in an environment in which sensing device 900 is deployed. In some embodiments, one or more sensors 200 of sensing device 900 may be an audio sensor, such as a directional or non-directional microphone, configured to detect sound in the environment and generate an electrical signal as a result. In this case, sensing device 900 permits two-way audio communication between a user at a host 600 and a person in an environment in which sensing device 900 is deployed.

Sensing device 900 also includes a lighting device 904 on one or more surfaces 212, 214. Lighting device 904 may be, for example, one or more light-emitting diodes 904 that provide directional or non-directional light. Lighting device 904 can be used to illuminate objects that are captured by one or more camera assemblies 224 of sensing device 900.

FIG. 10 illustrates another embodiment of a sensing device 1000. Sensing device 1000 includes one or more camera assemblies 224 and/or one or more sensors 220 on a surface of an enclosure 1010, such as a side surface 212 or top surface 1014, a bottom surface 1017 that may be weighted, as well as other features discussed above in connection with FIGS. 2-9, the description of which will not be repeated here. Sensing device includes a number of side surfaces 1012. For example, enclosure 1010 of sensor device 1000 may include six side surfaces 1012 to form a hexagonal shape, eight side surfaces 1012 to form an octagonal shape, or any number of more or fewer sides surfaces 1012, one or more of which may include a camera assembly 224, sensors 220, or both. Top surface 1014 may include a tether attachment connector 216 described above in connection with FIG. 2, and may include a wireless connection 102 (FIG. 1) or a wired tether 810 (FIG. 8). As discussed above in connection with FIG. 9, top surface 1014 may also include one or more camera assemblies 224, sensors 220, or both. In a further embodiment, enclosure 1010 may also include a shock-absorbing casing 1022 and rounded or beveled edges 1013 surrounding each face of sensor device 1000, providing for easier deployment of sensor device 1000.

FIG. 11 illustrates another embodiment of a sensing device 1100. Sensing device 1100 includes one or more camera assemblies 224 and/or one or more sensors 220 on a surface of an enclosure 1110, a bottom surface 1117 that may be weighted, a top surface 1114, as well as other features discussed above in connection with FIGS. 2-10, the description of which will not be repeated here. Sensing device 1100 includes a rounded side surface 1112 with one or more camera assemblies 224 and/or one or more sensors 220. Top surface 1114 may include a tether attachment connector 216 described above in connection with FIG. 2, and may include a wireless connection 102 (FIG. 1) or a wired tether 810 (FIG. 8). As discussed above in connection with FIG. 9, top surface 1114 may also include one or more camera assemblies 224, sensors 220, or both. In a further embodiment, enclosure 1110 may also include a shock-absorbing casing 1122 and rounded or beveled edges 1113 surrounding the rounded side surface 1112, top surface 1114, and bottom surface 1117 of sensor device 1100.

Embodiments described herein include methods, systems, and apparatuses for obtaining images and environmental information from potentially hazardous environments. The described embodiments provide a system and method for collecting environmental information and images from potentially hazardous environments, while preserving the health and lives of the damage control teams. For example, the embodiments provide for rapid situational assessment of environments such as the compartment of a ship, including views within the compartment and detection of heat and/or other potentially hazardous environmental conditions, thus facilitating coordination of a response and mitigating damage to rescuers, responders, victims, and property.

It should be understood that while preferred embodiments are described, embodiments of the invention are not limited to those described above, but also may include other variants and/or additions. For instance, steps in described methods may occur in varying orders, and several steps may occur in parallel. Components of described apparatuses may include obvious variants and other components that achieve the same functional purpose. Accordingly, the invention should be limited only by the claims below.

What is claimed as new and desired to be protected by Letters Patent is:

1. A deployable device for collecting information, the deployable device comprising:
an enclosure configured to move along a ground area, wherein the enclosure includes a plurality of surfaces including at least one side surface, a top surface, and a bottom surface;
at least one camera assembly or sensor inlaid in at least one of the enclosure surfaces;
a communications interface for transmitting, from the deployable device to a host, information collected by the at least one camera assembly or sensor.

2. The deployable device of claim 1, wherein the device comprises at least one sensor inlaid in at least one of the enclosure surfaces.

3. The deployable device of claim 1, wherein the device comprises at least one camera assembly inlaid in at least one of the enclosure surfaces.

4. The deployable device of claim 1, wherein the device comprises at least one sensor inlaid in at least one of the enclosure surfaces and at least one camera assembly inlaid in at least one of the enclosure surfaces.

5. The deployable device of claim 2, wherein the at least one sensor comprises an audio sensor configured to generate a signal in response to the sensed presence of audible sound.

6. The deployable device of claim 1, further comprising at least one audio speaker in at least one of the enclosure surfaces.

7. The deployable device of claim 1, wherein the enclosure comprises four substantially flat side surfaces.

8. The deployable device of claim 1, wherein the enclosure comprises more than four substantially flat side surfaces.

9. The deployable device of claim 1, wherein the enclosure comprises a rounded side surface.

10. The deployable device of claim 1, wherein the enclosure further comprises a weighted bottom surface configured to rest on the ground surface when the deployable device comes to rest.

11. The deployable device of claim 1, wherein the at least one side surface comprises beveled edges.

12. The deployable device of claim 1, wherein the at least one camera assembly or sensor is located on a top surface of the enclosure.

13. The deployable device of claim 1, wherein the at least one camera assembly or sensor is located on a side surface of the enclosure.

14. The deployable device of claim 3, further comprising a lighting mechanism on a same surface as the at least one camera assembly.

15. The deployable device of claim 14, wherein the lighting mechanism comprises a light emitting diode.

16. The deployable device of claim 1, wherein the deployable device comprises a wired tether.

17. The deployable device of claim 16, wherein the wired tether provides power to the deployable device.

18. The deployable device of claim 16, wherein the wired tether comprises the communications interface.

19. The deployable device of claim 16, wherein the wired tether provides control information to the deployable device.

20. The deployable device of claim 1, further comprising an internal temperature sensor configured to monitor an internal temperature of the deployable device.

21. A method of collecting information comprising:
deploying a device into an environment by rolling the device into the environment;
obtaining information about the environment with the device;
transmitting the obtained information from the device to a host.

22. The method of claim 21, wherein the information comprises image information.

23. The method of claim 21, wherein the information comprises environmental information.

24. The method of claim 21, wherein the information comprises image and environmental information.

25. The method of claim 23, wherein the environmental information comprises audio information.

26. The method of claim 21, further comprising:
transmitting audio information from the host to the device; and
outputting the audio information from the device using a speaker.

27. The method of claim 21, wherein the device comprises a wired tether.

28. The method of claim 27, wherein transmitting the obtained information from the device to the host comprises transmitting the obtained information over the wired tether.

29. The method of claim 27, wherein deploying the device comprises swinging the device using the wired tether.

30. The method of claim 27, wherein deploying the device comprises lowering the device using the wired tether.

31. The method of claim 27, further comprising transmitting power to the device over the wired tether.

32. The method of claim 27, further comprising transmitting control information to the device over the wired tether.

33. The method of claim 21, wherein the device comprises four side surfaces.

34. The method of claim 21, wherein the device comprises more than four side surfaces.

35. The method of claim 21, wherein the device comprises a rounded surface.

36. The method of claim 21, wherein the device comprises beveled edges.

37. The method of claim 21, wherein rolling the device comprises rolling the device by hand into the environment.

38. The method of claim 21, wherein the device further comprises a weighted bottom surface configured to rest on the floor when the device conies to rest.

39. The method of claim 21, further comprising monitoring an internal temperature of the device.

40. The method of claim 21, wherein the information is obtained by a camera assembly or sensor located in a side surface of the device.

42. The method of claim 21, wherein the information is obtained by a camera assembly or sensor located in a top surface of the device.

43. The method of claim 22, further comprising illuminating an object for which image information is to be captured.
